(19) United States
(12) Patent Application Publication
(10) Pub. No.: US 2024/0137907 A1
(43) Pub. Date: Apr. 25, 2024

(54) DETERMINING RANDOM-ACCESS RESOURCES FOR GROUP PAGING

(71) Applicant: Nokia Technologies Oy, Espoo (FI)

(72) Inventors: David NAVRATIL, Espoo (FI); Volker PAULI, Munich (DE)

(21) Appl. No.: 18/547,443

(22) PCT Filed: Mar. 11, 2022
(86) PCT No.: PCT/FI2022/050159

§ 371 Date: Aug. 21, 2023

(30) Foreign Application Priority Data
Mar. 21, 2021 (FI) 20215314

(51) Int. Cl. H04W 68/00; H04W 74/0833

(52) U.S. Cl. CPC H04W 68/005; H04W 74/0833

(57) ABSTRACT

Disclosed is a method comprising determining an alternative set of random-access resources based at least partly on an estimated number of idle and/or inactive terminal devices, wherein the alternative set of random-access resources comprises at least one or more random-access resources that are not comprised in an initial set of random-access resources indicated by an initial set of configuration parameters at the estimated number of idle and/or inactive terminal devices. A group paging message indicating at least the alternative set of random-access resources and a group identifier is transmitted to the estimated number of idle and/or inactive terminal devices.

### FIELD

The following exemplary embodiments relate to wireless communication.

### BACKGROUND

As resources are limited, it is desirable to optimize the usage of network resources. A cell in a cellular communication network may be utilized such that better usage of resources may be provided to one or more terminal devices.

### SUMMARY

The scope of protection sought for various exemplary embodiments is set out by the independent claims. The exemplary embodiments and features, if any, described in this specification that do not fall under the scope of the independent claims are to be interpreted as examples useful for understanding various exemplary embodiments.

According to an aspect, there is provided an apparatus comprising at least one processor, and at least one memory including computer program code, wherein the at least one memory and the computer program code are configured, with the at least one processor, to cause the apparatus to: determine an alternative set of random-access resources based at least partly on an estimated number of idle and/or inactive terminal devices, wherein the alternative set of random-access resources comprises at least one or more random-access resources that are not comprised in an initial set of random-access resources indicated by an initial set of configuration parameters at the estimated number of idle and/or inactive terminal devices; and transmit, to the estimated number of idle and/or inactive terminal devices, a group paging message indicating at least the alternative set of random-access resources and a group identifier.

According to another aspect, there is provided an apparatus comprising means for: determining an alternative set of random-access resources based at least partly on an estimated number of idle and/or inactive terminal devices, wherein the alternative set of random-access resources comprises at least one or more random-access resources that are not comprised in an initial set of random-access resources indicated by an initial set of configuration parameters at the estimated number of idle and/or inactive terminal devices; and transmitting, to the estimated number of idle and/or inactive terminal devices, a group paging message indicating at least the alternative set of random-access resources and a group identifier.

According to another aspect, there is provided a method comprising: determining an alternative set of random-access resources based at least partly on an estimated number of idle and/or inactive terminal devices, wherein the alternative set of random-access resources comprises at least one or more random-access resources that are not comprised in an initial set of random-access resources indicated by an initial set of configuration parameters at the estimated number of idle and/or inactive terminal devices; and transmitting, to the estimated number of idle and/or inactive terminal devices, a group paging message indicating at least the alternative set of random-access resources and a group identifier.

According to another aspect, there is provided a computer program comprising instructions for causing an apparatus to perform at least the following: determine an alternative set of random-access resources based at least partly on an estimated number of idle and/or inactive terminal devices, wherein the alternative set of random-access resources comprises at least one or more random-access resources that are not comprised in an initial set of random-access resources indicated by an initial set of configuration parameters at the estimated number of idle and/or inactive terminal devices; and transmit, to the estimated number of idle and/or inactive terminal devices, a group paging message indicating at least the alternative set of random-access resources and a group identifier.

According to another aspect, there is provided a computer readable medium comprising program instructions for causing an apparatus to perform at least the following: determine an alternative set of random-access resources based at least partly on an estimated number of idle and/or inactive terminal devices, wherein the alternative set of random-access resources comprises at least one or more random-access resources that are not comprised in an initial set of random-access resources indicated by an initial set of configuration parameters at the estimated number of idle and/or inactive terminal devices; and transmit, to the estimated number of idle and/or inactive terminal devices, a group paging message indicating at least the alternative set of random-access resources and a group identifier.

According to another aspect, there is provided a non-transitory computer readable medium comprising program instructions for causing an apparatus to perform at least the following: determine an alternative set of random-access resources based at least partly on an estimated number of idle and/or inactive terminal devices, wherein the alternative set of random-access resources comprises at least one or more random-access resources that are not comprised in an initial set of random-access resources indicated by an initial set of configuration parameters at the estimated number of idle and/or inactive terminal devices; and transmit, to the estimated number of idle and/or inactive terminal devices, a group paging message indicating at least the alternative set of random-access resources and a group identifier.

According to another aspect, there is provided an apparatus comprising at least one processor, and at least one memory including computer program code, wherein the at least one memory and the computer program code are configured, with the at least one processor, to cause the apparatus to: estimate a number of idle terminal devices by determining how often a tracking area identifier occurs in one or more registration areas of the idle terminal devices; and transmit, to a base station, a group paging message indicating at least the estimated number of idle terminal devices and a group identifier.

According to another aspect, there is provided an apparatus comprising means for: estimating a number of idle terminal devices by determining how often a tracking area identifier occurs in one or more registration areas of the idle terminal devices; and transmitting, to a base station, a group paging message indicating at least the estimated number of idle terminal devices and a group identifier.

According to another aspect, there is provided a method comprising: estimating a number of idle terminal devices by determining how often a tracking area identifier occurs in one or more registration areas of the idle terminal devices; and transmitting, to a base station, a group paging message indicating at least the estimated number of idle terminal devices and a group identifier.

According to another aspect, there is provided a computer program comprising instructions for causing an apparatus to perform at least the following: estimate a number of idle terminal devices by determining how often a tracking area identifier occurs in one or more registration areas of the idle terminal devices; and transmit, to a base station, a group paging message indicating at least the estimated number of idle terminal devices and a group identifier.

According to another aspect, there is provided a computer readable medium comprising program instructions for causing an apparatus to perform at least the following: estimate a number of idle terminal devices by determining how often a tracking area identifier occurs in one or more registration areas of the idle terminal devices; and transmit, to a base station, a group paging message indicating at least the estimated number of idle terminal devices and a group identifier.

According to another aspect, there is provided a non-transitory computer readable medium comprising program instructions for causing an apparatus to perform at least the following: estimate a number of idle terminal devices by determining how often a tracking area identifier occurs in one or more registration areas of the idle terminal devices; and transmit, to a base station, a group paging message indicating at least the estimated number of idle terminal devices and a group identifier.

According to an aspect, there is provided an apparatus comprising at least one processor, and at least one memory including computer program code, wherein the at least one memory and the computer program code are configured, with the at least one processor, to cause the apparatus to: receive a configuration comprising an initial set of random-access resources; receive a group paging message comprising an indication of an alternative set of random-access resources, wherein the alternative set of random-access resources comprises at least one or more random-access resources that are not comprised in the initial set of random-access resources; and transmit a first random-access message using a first random-access resource selected from the alternative set of random-access resources; wherein the apparatus is comprised in a terminal device.

According to another aspect, there is provided an apparatus comprising means for: receiving a configuration comprising an initial set of random-access resources; receiving a group paging message comprising an indication of an alternative set of random-access resources, wherein the alternative set of random-access resources comprises at least one or more random-access resources that are not comprised in the initial set of random-access resources; and transmitting a first random-access message using a first random-access resource selected from the alternative set of random-access resources; wherein the apparatus is comprised in a terminal device.

According to another aspect, there is provided a method comprising: receiving, by a terminal device, a configuration comprising an initial set of random-access resources; receiving, by the terminal device, a group paging message comprising an indication of an alternative set of random-access resources, wherein the alternative set of random-access resources comprises at least one or more random-access resources that are not comprised in the initial set of random-access resources; and transmitting, by the terminal device, a first random-access message using a first random-access resource selected from the alternative set of random-access resources.

According to another aspect, there is provided a computer program comprising instructions for causing an apparatus to perform at least the following: receive a configuration comprising an initial set of random-access resources; receive a group paging message comprising an indication of an alternative set of random-access resources, wherein the alternative set of random-access resources comprises at least one or more random-access resources that are not comprised in the initial set of random-access resources; and transmit a first random-access message using a first random-access resource selected from the alternative set of random-access resources; wherein the apparatus is comprised in a terminal device.

According to another aspect, there is provided a computer readable medium comprising program instructions for causing an apparatus to perform at least the following: receive a configuration comprising an initial set of random-access resources; receive a group paging message comprising an indication of an alternative set of random-access resources, wherein the alternative set of random-access resources comprises at least one or more random-access resources that are not comprised in the initial set of random-access resources; and transmit a first random-access message using a first random-access resource selected from the alternative set of random-access resources; wherein the apparatus is comprised in a terminal device.

According to another aspect, there is provided a non-transitory computer readable medium comprising program instructions for causing an apparatus to perform at least the following: receive a configuration comprising an initial set of random-access resources; receive a group paging message comprising an indication of an alternative set of random-access resources, wherein the alternative set of random-access resources comprises at least one or more random-access resources that are not comprised in the initial set of random-access resources; and transmit a first random-access message using a first random-access resource selected from the alternative set of random-access resources; wherein the apparatus is comprised in a terminal device.

According to another aspect, there is provided a system comprising at least a base station and a terminal device. The base station is configured to: transmit, to the terminal device, an initial set of configuration parameters comprising an initial set of random-access resources; determine an alternative set of random-access resources based at least partly on an estimated number of idle and/or inactive terminal devices, wherein the alternative set of random-access resources comprises at least one or more random-access resources that are not comprised in the initial set of random-access resources; and transmit, to the terminal device, a group paging message indicating at least the alternative set of random-access resources and a group identifier, wherein the terminal device is comprised in the estimated number of idle and/or inactive terminal devices. The terminal device is configured to: receive, from the base station, the initial set of configuration parameters comprising the initial set of random-access resources; receive, from the base station, the group paging message indicating the alternative set of random-access resources; and transmit, to the base station, a first random-access message using a first random-access resource selected from the alternative set of random-access resources.

According to another aspect, there is provided a system comprising at least a base station and a terminal device. The base station comprises means for: transmitting, to the terminal device, an initial set of configuration parameters comprising an initial set of random-access resources; determining an alternative set of random-access resources based at least partly on an estimated number of idle and/or inactive terminal devices, wherein the alternative set of random-access resources comprises at least one or more random-access resources that are not comprised in the initial set of random-access resources; and transmitting, to the terminal device, a group paging message indicating at least the alternative set of random-access resources and a group identifier, wherein the terminal device is comprised in the estimated number of idle and/or inactive terminal devices. The terminal device comprises means for: receiving, from the base station, the initial set of configuration parameters comprising the initial set of random-access resources; receiving, from the base station, the group paging message indicating the alternative set of random-access resources; and transmitting, to the base station, a first random-access message using a first random-access resource selected from the alternative set of random-access resources.

### BRIEF DESCRIPTION OF THE DRAWINGS

In the following, various exemplary embodiments will be described in greater detail with reference to the accompanying drawings, in which

FIG. 1 illustrates an exemplary embodiment of a cellular communication network;

FIG. 2 illustrates a signaling diagram for group paging over registration area;

FIG. 3 illustrates a signaling diagram according to an exemplary embodiment;

FIGS. 4-8 illustrate flow charts according to some exemplary embodiments;

FIGS. 9-11 illustrate apparatuses according to some exemplary embodiments.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. In the following, different exemplary embodiments will be described using, as an example of an access architecture to which the exemplary embodiments may be applied, a radio access architecture based on long term evolution advanced (LTE Advanced, LTE-A) or new radio (NR, 5G), without restricting the exemplary embodiments to such an architecture, however. It is obvious for a person skilled in the art that the exemplary embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

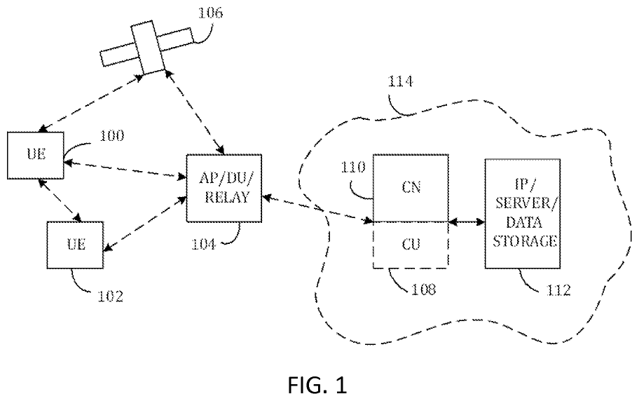

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The exemplary embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB may be called uplink or reverse link and the physical link from the (e/g)NodeB to the user device may be called downlink or forward link. It should be appreciated that (e/g)NodeBs or their functionalities may be implemented by using any node, host, server or access point etc. entity suitable for such a usage.

A communication system may comprise more than one (e/g)NodeB, in which case the (e/g)NodeBs may also be configured to communicate with one another over links, wired or wireless, designed for the purpose. These links may be used for signaling purposes. The (e/g)NodeB may be a computing device configured to control the radio resources of communication system it is coupled to. The NodeB may also be referred to as a base station, an access point or any other type of interfacing device including a relay station capable of operating in a wireless environment. The (e/g)NodeB may include or be coupled to transceivers. From the transceivers of the (e/g)NodeB, a connection may be provided to an antenna unit that establishes bi-directional radio links to user devices. The antenna unit may comprise a plurality of antennas or antenna elements. The (e/g)NodeB may further be connected to core network 110 (CN or next generation core NGC). Depending on the system, the counterpart on the CN side may be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface may be allocated and assigned, and thus any feature described herein with a user device may be implemented with a corresponding apparatus, such as a relay node. An example of such a relay node may be a layer 3 relay (self-backhauling relay) towards the base station.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation may be carried out in the cloud. The user device (or in some exemplary embodiments a layer 3 relay node) may be configured to perform one or more of user equipment functionalities. The user device may also be called a subscriber unit, mobile station, remote terminal, access terminal, user terminal, terminal device, or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G may enable using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may be expected to have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave, below 6 GHz-cmWave-mmWave). One of the concepts considered to be used in 5G networks may be network slicing in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or a radio unit (RU), or a base station comprising radio parts. It may also be possible that node operations will be distributed among a plurality of servers, nodes or hosts. Carrying out the RAN real-time functions at the RAN side (in a distributed unit, DU 104) and non-real time functions in a centralized manner (in a centralized unit, CU 108) may be enabled for example by application of cloudRAN architecture.

It should also be understood that the distribution of labour between core network operations and base station operations may differ from that of the LTE or even be non-existent. Some other technology advancements that may be used may be Big Data and all-IP, which may change the way networks are being constructed and managed. 5G (or new radio, NR) networks may be designed to support multiple hierarchies, where MEC servers may be placed between the core and the base station or nodeB (gNB). It should be appreciated that MEC may be applied in 4G networks as well.

5G may also utilize satellite communication to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). At least one satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may also comprise other apparatuses, such as physical layer relay nodes or other network elements, etc. At least one of the (e/g)NodeBs or may be a Home (e/g)nodeB.

Furthermore, the (e/g)nodeB or base station may also be split into: a radio unit (RU) comprising a radio transceiver (TRX), i.e. a transmitter (TX) and a receiver (RX); a distributed unit (DU) that may be used for the so-called Layer 1 (L1) processing and real-time Layer 2 (L2) processing; and a centralized unit (CU) or a central unit that may be used for non-real-time L2 and Layer 3 (L3) processing. Such a split may enable the centralization of CUs relative to the cell sites and DUs, whereas DUs may be more distributed and may even remain at cell sites. The CU and DU together may also be referred to as baseband or a baseband unit (BBU). The RU and DU may also be comprised into a radio access point (RAP). Cloud computing platforms may also be used to run the CU or DU. The CU may run in a cloud computing platform (vCU, virtualized CU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned base station units, or different core network operations and base station operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In multilayer networks, one access node may provide one kind of a cell or cells, and thus a plurality of (e/g)NodeBs may be needed to provide such a network structure.

For fulfilling the need for improving the deployment and performance of communication systems, the concept of “plug-and-play” (e/g)NodeBs may be introduced. A network which may be able to use “plug-and-play” (e/g) Node Bs, may include, in addition to Home (e/g)NodeBs (H(e/g)nodeBs), a home node B gateway, or HNB-GW (not shown in FIG. 1). A HNB Gateway (HNB-GW), which may be installed within an operator's network, may aggregate traffic from a large number of HNBs back to a core network.

NR multicast and broadcast services (MBS) may provide support for multicast and broadcast services in NR. A broadcast service is a communication service, in which a specific service and specific content data are provided substantially simultaneously to the UEs in the broadcast coverage area (i.e. any UE in the broadcast coverage area is authorized to receive the data). A multicast service is a communication service, in which a specific service and specific content data are provided substantially simultaneously to a dedicated set of UEs that are specifically authorized to receive the data (i.e. not all UEs in the multicast coverage area may be authorized to receive the data). The activation procedure for an MBS session, i.e. a session for delivering a multicast communication service or a broadcast communication service, may be performed for example by delivering an individual paging message to one or more UEs, or by performing group paging to a group of UEs. A broadcast session may be characterized by the content to be sent and the geographical area in which to distribute the content. A multicast session may be characterized by the content to be sent, the list of UEs that may receive the service, and optionally by a multicast area in which to distribute the content.

After the multicast/broadcast session management function (MB-SMF) receives the trigger to re-activate the MBS session, for example one of the three following approaches may be used for the re-activation of idle mode UEs depending on the type of paging used: individual paging, group paging over registration area (RA), or group paging over service area (SA).

In individual paging, the MB-SMF identifies the session management function(s) (SMF) involved in the MBS session and sends an activate message to these SMF(s). The SMF(s) identifies the deactivated MBS-related protocol data unit (PDU) sessions and triggers individual PDU session request messages to the access and mobility management function (AMF). The AMF identifies that the involved UE is idle and retrieves its RA. The AMF pages this individual UE. The UE replies with a service request to get connected. A user plane connection of the PDU session is activated again.

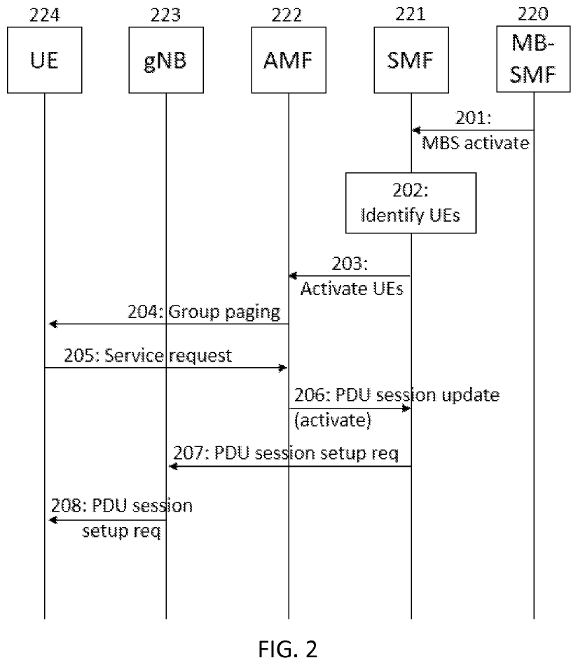

FIG. 2 illustrates a signaling diagram for group paging over RA. An MB-SMF 220 identifies one or more SMFs 221 involved in the MBS session and transmits 201 an MBS activate message to these one or more SMFs. The MBS activate message may comprise an MBS session identifier, for example. The one or more SMFs identify 202 a plurality of UEs with deactivated PDU sessions. In other words, the one or more SMFs identify the deactivated MBS-related PDU sessions and the corresponding idle UEs. The one or more SMFs transmit 203 an activate message comprising a list of the identified UEs to an AMF 222. The activate message 203 also comprises an indication to activate the identified UEs. The AMF determines a group paging area corresponding to the union of the involved RAs and triggers a group paging (i.e. paging with group identifier) to this group paging area. The AMF transmits 204 a group paging message to the plurality of identified UEs 224 in the group paging area. The plurality of UEs reply to the group paging message by transmitting 205 a service request to the AMF to get connected. The AMF transmits 206 a PDU session update request message to the one or more SMFs to activate the PDU session. The one or more SMFs transmit 207 a PDU session setup request or a PDU session update response to a base station 223, for example a gNB. The PDU session setup request or the PDU session update response may comprise the MBS session identifier, for example. The base station forwards 208 the PDU session setup request or the PDU session update response to the plurality of identified UEs. A user plane connection of the PDU session is activated again.

Alternatively, group paging may be performed over SA. In this case, the MB-SMF knows the MBS service area associated with the MBS session, and sends an activate message toward the AMF comprising the MBS service area. The MBS service area may be defined by a list of tracking area identifiers, a list of NG-RAN node identifiers, etc. The AMF triggers a group paging (i.e. paging with group identifier) over this service area. The involved UE replies with a service request to get connected. The PDU session is re-activated.

It should be noted that individual paging may cause a high load on the paging channel, whereas in group paging the load over the paging channel is reduced in comparison to individual paging. It should also be noted that in group paging over SA, the paging area may be larger than in group paging over RA, since the full service area is paged in group paging over SA regardless of where the UEs are located (i.e. regardless of the RA). Therefore, group paging over RA may generate less paging load than individual paging or group paging over SA.

However, group paging may cause collisions on the resources available for random access. The collision probability increases as the number of UEs in the group grows. In addition, the resources for random access may be configured in a semi-static manner via system information based on the long-term expected load in a cell. The above group paging approaches may not be suitable for multicast services, because the number of UEs that may join a multicast session may be difficult to predict. Furthermore, the above group paging approaches may not address the issue of potentially massive congestion on the random-access channel that such a group paging may incur.

Some exemplary embodiments may provide a solution for dynamic allocation of random-access resources that considers the number of UEs that may be camping on a cell. In some exemplary embodiments, a RAN node such as a gNB determines the size of the random-access resource set based on the expected number of UEs in a group camping in a cell, a tracking area, and/or a RAN notification area.

For RAN paging, it may be assumed that the RAN node maintains, for a given UE in a radio resource control (RRC) inactive state, the UE's context comprising information about the multicast groups that the UE has joined. This way, the RAN node knows the number of UEs that are expected to respond to a group paging in a RAN notification area, and the RAN node uses this information to determine the size of the random-access resource set.

For core network (CN) paging, the operation of the AMF may be modified in comparison to the group paging over RA approach illustrated in FIG. 2 such that, in addition to the computation of the union of the involved RAs referred to as a group paging area, which may comprise a list of tracking area identifiers (TAIs), the AMF also computes how often a TAI occurs in the UEs' registration areas, i.e. the expected number of UEs in the group per TAI. The expected number of UEs in the group per TAI is then provided to the RAN in a group paging message over RA. The RAN node uses the received expected number of UEs per TAI to determine the size of the random-access resource set.

In case there is a single group paging over the air that does not differentiate between RAN paging and CN paging, then the RAN node may determine the number of UEs to be paged in an area, for example RAN notification area, as the sum of the number of UEs in RRC inactive state and the expected number of UEs indicated in the paging message received from the AMF.

As the number of UEs in the group and in an area may change dynamically, and as some exemplary embodiments may be used for the random-access procedure initiated by the UEs in response to the group paging message, the UEs may be informed about the random-access resource set or the size of the resource set in the group paging message along with a group identifier, for example a temporary mobile group identity.

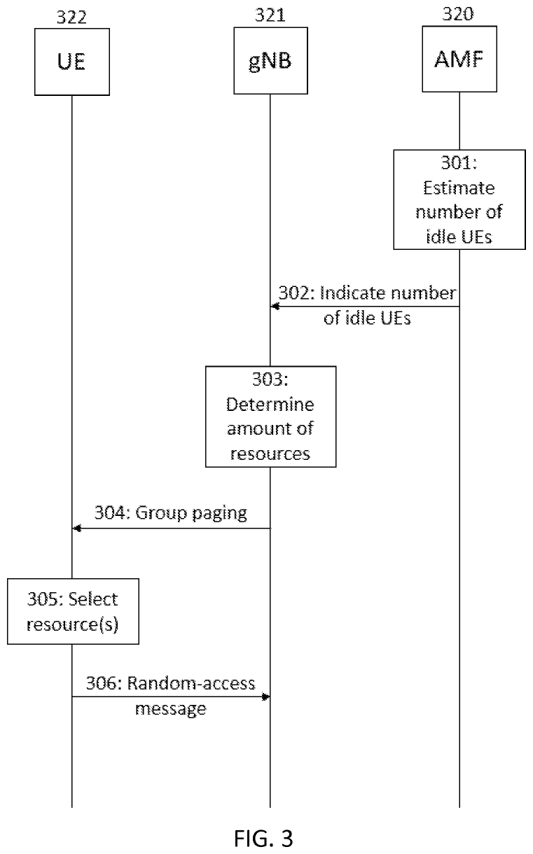

FIG. 3 illustrates a signaling diagram according to an exemplary embodiment. An AMF 320 estimates 301, per a tracking area, a number of idle UEs by determining how often a tracking area identifier occurs in one or more registration areas of the idle UEs. The AMF indicates 302, or transmits, the estimated number of idle UEs to a base station 321, for example a gNB. The estimated number of idle UEs may be indicated 302 in a group paging message, for example. The base station determines 303 an amount of random-access resources based at least partly on the estimated number of idle UEs received from the AMF and/or a number of UEs in RRC inactive state. The random-access resources may comprise time and/or frequency resources, for example. The base station transmits 304 a group paging message to the estimated number of idle UEs 322 and/or to the number of UEs 322 in RRC inactive state, wherein the group paging message indicates at least the determined amount of random-access resources. The idle and/or inactive UEs 322 then select a random-access resource 305 from the random-access resources as indicated in the group paging message, and use the selected resources for one or more random-access attempts, i.e. for transmitting 306 a random-access message to the base station in response to the group paging message.

In another exemplary embodiment for increasing PRACH resources in the time domain, a coefficient K indicating the number of physical random access channel (PRACH) occasion repetitions in time may be used. In this exemplary embodiment, the RACH-ConfigCommon in the system information may remain unchanged. RACH-ConfigCommon is a set of configuration parameters that provides the UEs with the configuration of PRACH resources for individual paging and defines how many PRACH occasions there are in which slots of a system frame. The UEs may receive RACH-ConfigCommon for example in a system information block type 1 (SIB1) in the common configuration of a serving cell. In other words, RACH-ConfigCommon is signaled to the UEs separately before the group paging message. The group paging message may thus be used to signal a parameter K such that, instead of randomly selecting a resource from the PRACH occasions signaled in RACH-ConfigCommon, a given UE does so from K successive occurrences of this PRACH occasions pattern.

In another exemplary embodiment for increasing PRACH resources in the time domain, a PRACH configuration index (prach-Configurationlndex) may be used. prach-Configurationlndex is an index to a table of random-access configurations, and this table defines PRACH resources among other things in terms of slots in which PRACH resources are available. prach-Configurationlndex may be provided in the RACH-ConfigCommon, i.e. the configuration of common random-access resources in the cell. This exemplary embodiment may also utilize RACH-ConfigCommon. In other words, no additional information may be provided in the system information (i.e. SIB1). If the gNB determines that the number of random-access resources configured commonly for the UEs in the RACH-ConfigCommon in SIB1 is not sufficient, then the gNB may increase the resource capacity by signaling a new value of the PRACH configuration index, for example an integer number between 0 and 255, in the group paging message. A UE receiving the group paging message comprising the new value of the PRACH configuration index then uses this new value instead of the original value provided in the SIB1 for a specific time, for example a number of radio frames, which may also be signaled in the group paging message or in system information, or alternatively the number of radio frames may be a standardized value. For example, (if the duplexing mode allows this) going from a PRACH configuration index of 0 to a PRACH configuration index of 27 may correspond to a 160-fold increase in PRACH capacity. As a result, the scheduler may have to temporarily adjust to leave those resources vacant, but it would have the advantage of temporarily increasing PRACH capacity significantly.

In another exemplary embodiment for increasing PRACH resources in the frequency domain, the number of PRACH transmission occasions may be frequency-division multiplexed (FDMed). The number of resources in the frequency domain may be temporarily increased by signaling a different value of msg1-FDM than provided in the RACH-ConfigCommon in the system information (i.e. SIB1). Msg1-FDM is a configuration parameter, which defines the number of PRACH transmission occasions in the frequency domain in one time instance. The value of msg1-FDM may be, for example, 1, 2, 4 or 8. A UE receiving the group paging message comprising the new value of the msg1-FDM then uses this new value for a specific time instead of the original msg1-FDM value in SIB1. As a non-limiting example, if SIB1 configures msg1-FDM=2, and if the group paging message configures a new value msg1-FDM=8, then the amount of PRACH resources is increased by a factor of 4 by using the new value instead of the original value provided in SIB1.

The three exemplary embodiments described above are based on re-using the random-access resource configuration that is intended for individual paging, i.e. RACH-ConfigCommon, for group paging. Another exemplary embodiment may apply one or more separate configurations of random-access resources for group paging. In this exemplary embodiment, the one or more separate configurations of random-access resources for group paging may be provided in the system information, for example as a list. In other words, the RACH-ConfigCommon provided in SIB1 may be kept unchanged, but a list of other RACH-ConfigCommon information elements (IE) may be provided by system information, for example in another SIB. The different RACH-ConfigCommon lEs may be used to configure different amounts of PRACH (random-access) resources. The gNB selects the RACH-ConfigCommon IE that provides the most appropriate amount of resources for the estimated number of idle and/or inactive UEs. An index pointing to the list of RACH-ConfigCommon may then be provided in the group paging message to indicate the selected RACH-ConfigCommon IE. In other words, the group paging message may comprise an index indicating the random-access resource configuration to be used from a set of random-access resource configurations. A UE receiving the group paging message comprising the index may then use the alternative configuration of RACH-ConfigCommon indicated by the index for a specific time. Alternatively, a UE receiving the group paging message comprising the index may be configured to use any PRACH resources configured in the alternative configuration of RACH-ConfigCommon indicated by the index and the cell's RACH-ConfigCommon (i.e. from SIB) for a specific time.

The exemplary embodiments described above may be used individually, or two or more of them may be used together in any combination.

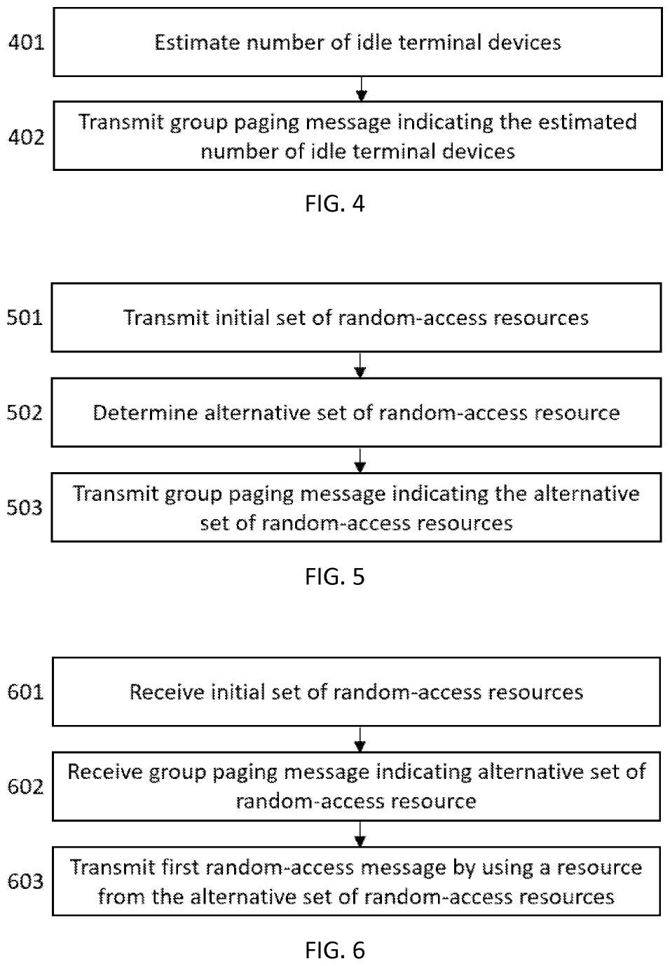

FIG. 4 illustrates a flow chart according to an exemplary embodiment. The functions illustrated in FIG. 4 may be performed by an apparatus such as an AMF, or an apparatus comprised in an AMF. Referring to FIG. 4, a number of idle UEs is estimated 401 by determining how often a tracking area identifier occurs in one or more registration areas of the idle UEs. A group paging message indicating at least the estimated number of idle UEs and a group identifier is transmitted 402 to a base station.

FIG. 5 illustrates a flow chart according to another exemplary embodiment. The functions illustrated in FIG. 5 may be performed by an apparatus such as a base station (for example a gNB), or an apparatus comprised in a base station. Referring to FIG. 5, an initial set of configuration parameters comprising an initial set of random-access resources is transmitted 501 to a plurality of UEs. The initial set of configuration parameters may comprise, for example, RACH-ConfigCommon, which may be comprised in SIB1, for example. An alternative set of random-access resources is determined 502 based at least partly on an estimated number of idle and/or inactive UEs, wherein the alternative set of random-access resources comprises at least one or more random-access resources that are not comprised in the initial set of random-access resources indicated by the initial set of configuration parameters. The estimated number of idle and/or inactive UEs may be comprised in the plurality of UEs. The estimated number of idle and/or inactive terminal devices may be determined based at least partly on a first number of UEs in a RRC inactive state and/or a second number of UEs indicated in a paging message received from an AMF. As a non-limiting example, the alternative set of random-access resources may comprise a higher amount of random-access resources than the initial set of random-access resources. As another non-limiting example, the alternative set of random-access resources may be defined such that the responses from the idle and/or inactive UEs to the group paging do not collide with other random-access attempts of other UEs in the initial set of random-access resources. A group paging message indicating at least the alternative set of random-access resources and a group identifier is transmitted 503 to the estimated number of idle and/or inactive UEs.

The initial set of configuration parameters may comprise at least a pattern of random-access resources, wherein the alternative set of random-access resources comprises a number of repetitions of the pattern of random-access resources, wherein the number of repetitions is indicated at least partly by a coefficient comprised in the group paging message.

The alternative set of random-access resources may be indicated at least partly by a second value of a first index for overriding a first value of the first index comprised in the initial set of configuration parameters, wherein the second value is comprised in the group paging message. The first value comprised in the initial set of configuration parameters indicates an initial amount of time resources comprised in the initial set of random-access resources. The second value comprised in the group paging message indicates an alternative amount of time resources comprised in the alternative set of random-access resources.

The alternative set of random-access resources may be indicated at least partly by a fourth value of a parameter, wherein the fourth value indicates to increase an initial amount of frequency resources comprised in the initial set of random-access resources, wherein the fourth value is comprised in the group paging message, and wherein the initial amount of frequency resources is indicated by a third value of the parameter comprised in the initial set of configuration parameters.

In some exemplary embodiments, the group paging message may comprise a second index indicating an alternative set of configuration parameters from multiple sets of configuration parameters to be used instead of the initial set of configuration parameters, wherein the alternative set of configuration parameters at least partly indicates the alternative set of random-access resources.

In some exemplary embodiments, the group paging message may further comprise at least one of a maximum number of attempts, a number of system frames, and/or a time period for using the alternative set of random-access resources starting from the reception of the group paging message.

In some exemplary embodiments, the alternative set of random-access resources may comprise a completely different set of resources in frequency and/or time compared to the initial set of random-access resources.

FIG. 6 illustrates a flow chart according to another exemplary embodiment. The functions illustrated in FIG. 6 may be performed by an apparatus such as a UE, or an apparatus comprised in a UE. Referring to FIG. 6, an initial set of configuration parameters comprising an initial set of random-access resources is received 601 from a base station. A group paging message indicating an alternative set of random-access resources is received 602 from the base station, wherein the alternative set of random-access resources comprises at least one or more random-access resources that are not comprised in the initial set of random-access resources. A first random-access message is transmitted 603 to the base station by using a first random-access resource selected from the alternative set of random-access resources.

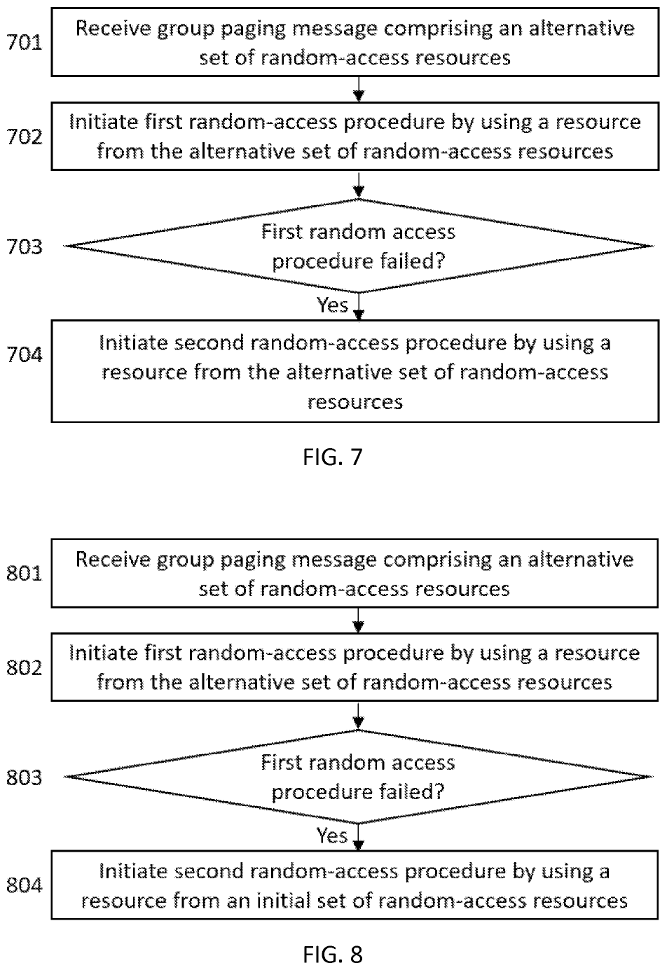

To cater for the situation, where the initial random-access procedure fails for a UE in the resources configured as described above, the following exemplary embodiments illustrated in FIGS. 7 and 8 may be applied for random-access resource configuration for further random-access attempts. A random-access procedure may be considered as failed, if, for example, no response is received from the gNB to the random-access message sent by the UE. The random-access procedure may also fail at a later stage, for example if at least two UEs happened to use substantially the same resource for sending a random-access message, in which case the random-access procedure may be completed successfully for just one of the UEs.

FIG. 7 illustrates a flow chart according to another exemplary embodiment. The functions illustrated in FIG. 7 may be performed by an apparatus such as a UE, or an apparatus comprised in a UE. Referring to FIG. 7, the UE receives 701, for example from a base station, a group paging message indicating an alternative set of random-access channel resources, wherein the alternative set of random-access channel resources comprises a different set of random-access channel resources than an initial set of random-access channel resources, for example RACH-ConfigCommon. For example, the alternative set of random-access channel resources may comprise an increased amount of resources compared to the initial set of random-access channel resources. The UE initiates 702 a first random-access procedure, i.e. transmits a first random-access message to the base station, by using a first resource selected from the alternative set of random-access channel resources. If the first random-access procedure failed (703: yes), then the UE initiates 704 a second random-access procedure, i.e. transmits a second random-access message to the base station, by using a second resource selected from the alternative set of random-access channel resources. If the second random-access procedure also fails, then the UE may continue to use the alternative set of random-access channel resources for further random-access attempts during the time when the alternative set is available until the UE declares complete failure or until a random-access procedure is successfully completed. The time during which the alternative set is available may be defined, for example, by a pre-defined maximum limit on the number of random-access attempts, or a number of slots or radio frames.

FIG. 8 illustrates a flow chart according to another exemplary embodiment. The functions illustrated in FIG. 8 may be performed by an apparatus such as a UE, or an apparatus comprised in a UE. Referring to FIG. 8, the UE receives 801, for example from a base station, a group paging message indicating an alternative set of random-access channel resources, wherein the alternative set of random-access channel resources comprises a different set of random-access channel resources than an initial set of random-access channel resources, for example RACH-ConfigCommon. For example, the alternative set of random-access channel resources may comprise an increased amount of resources compared to the initial set of random-access channel resources. The UE initiates 802 a first random-access procedure, i.e. transmits a first random-access message to the base station, by using a first resource selected from the alternative set of random-access channel resources. If the first random-access procedure failed (803: yes), then the UE initiates 804 a second random-access procedure, i.e. transmits a second random-access message to the base station, by using a second resource selected from the initial set of random-access channel resources. In other words, if the UE has not received a response from the base station to any random-access message transmitted during the time when the alternative set of random-access channel resources is available, and the UE has not reached the maximum allowed number of random-access message transmissions, then the UE may select a random-access resource from the initial set of random-access channel resources for further random-access attempts until the UE declares complete failure, i.e. when it has transmitted the maximum number of random access messages but has not received a response from the network.

The functions and/or blocks described above by means of FIGS. 2-8 are in no absolute chronological order, and some of them may be performed simultaneously or in an order differing from the described one. Other functions and/or blocks may also be executed between them or within them.

In another exemplary embodiment, the gNB indicates a number of periods of increased PRACH capacity (configured in any of the ways described above), which then also constitutes the number of random-access attempts a UE may perform with the increased resource capacity indicated by the alternative set of random-access resources before falling back to the initial configuration as per RACH-ConfigCommon. This number may be signaled in the group paging message, for example.

In another exemplary embodiment, if a UE needs to make an emergency call and was not able to send a random-access message yet, and the UE receives the group paging message while waiting for a RACH occasion, then the RACH resources currently available may be used to initiate the access for the emergency call.

A technical advantage provided by some exemplary embodiments is that the information about the number of expected UEs in idle mode comprised in the paging message from CN to RAN allows the RAN to estimate the expected load and determine the amount of random-access resources needed, which may result in less collision and thus faster access. In addition, in some exemplary embodiments the amount of random-access resources can be adjusted dynamically based on the expected load, and signaled to the UEs in a paging message with minimal overhead.

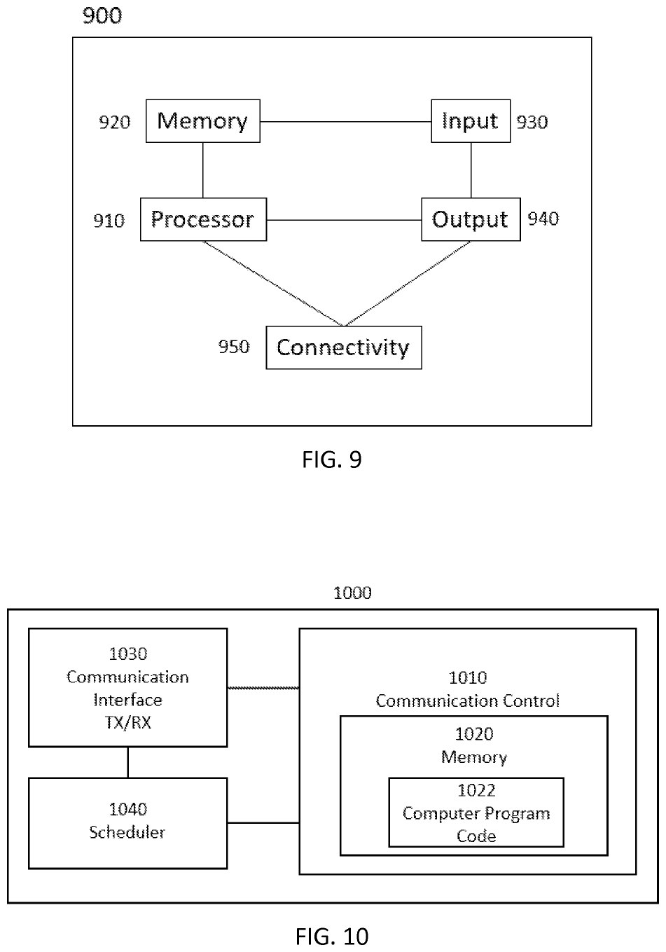

FIG. 9 illustrates an apparatus 900, which may be an apparatus such as, or comprised in, a terminal device, according to an exemplary embodiment. A terminal device may also be referred to as a UE or user equipment herein. The apparatus 900 comprises a processor 910. The processor 910 interprets computer program instructions and processes data. The processor 910 may comprise one or more programmable processors. The processor 910 may comprise programmable hardware with embedded firmware and may, alternatively or additionally, comprise one or more application-specific integrated circuits (ASICs).

The processor 910 is coupled to a memory 920. The processor is configured to read and write data to and from the memory 920. The memory 920 may comprise one or more memory units. The memory units may be volatile or non-volatile. It is to be noted that in some exemplary embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 920 stores computer readable instructions that are executed by the processor 910. For example, non-volatile memory stores the computer readable instructions and the processor 910 executes the instructions using volatile memory for temporary storage of data and/or instructions.

The computer readable instructions may have been pre-stored to the memory 920 or, alternatively or additionally, they may be received, by the apparatus, via an electromagnetic carrier signal and/or may be copied from a physical entity such as a computer program product. Execution of the computer readable instructions causes the apparatus 900 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 900 may further comprise, or be connected to, an input unit 930. The input unit 930 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 930 may comprise an interface to which external devices may connect to.

The apparatus 900 may also comprise an output unit 940. The output unit may comprise or be connected to one or more displays capable of rendering visual content, such as a light emitting diode (LED) display, a liquid crystal display (LCD) and/or a liquid crystal on silicon (LCoS) display. The output unit 940 may further comprise one or more audio outputs. The one or more audio outputs may be for example loudspeakers.

The apparatus 900 further comprises a connectivity unit 950. The connectivity unit 950 enables wireless connectivity to one or more external devices. The connectivity unit 950 comprises at least one transmitter and at least one receiver that may be integrated to the apparatus 900 or that the apparatus 900 may be connected to. The at least one transmitter comprises at least one transmission antenna, and the at least one receiver comprises at least one receiving antenna. The connectivity unit 950 may comprise an integrated circuit or a set of integrated circuits that provide the wireless communication capability for the apparatus 900. Alternatively, the wireless connectivity may be a hardwired application-specific integrated circuit (ASIC). The connectivity unit 950 may comprise one or more components such as a power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 900 may further comprise various components not illustrated in FIG. 9. The various components may be hardware components and/or software components.

The apparatus 1000 of FIG. 10 illustrates an exemplary embodiment of an apparatus such as, or comprised in, a base station such as a gNB. The apparatus may comprise, for example, a circuitry or a chipset applicable for realizing some of the described exemplary embodiments. The apparatus 1000 may be an electronic device comprising one or more electronic circuitries. The apparatus 1000 may comprise a communication control circuitry 1010 such as at least one processor, and at least one memory 1020 including a computer program code (software) 1022 wherein the at least one memory and the computer program code (software) 1022 are configured, with the at least one processor, to cause the apparatus 1000 to carry out some of the exemplary embodiments described above.

The memory 1020 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some exemplary embodiments, structures of the frames used in the detected neighbour cells.

The apparatus 1000 may further comprise a communication interface 1030 comprising hardware and/or software for realizing communication connectivity according to one or more communication protocols. The communication interface 1030 comprises at least one transmitter (TX) and at least one receiver (RX) that may be integrated to the apparatus 1000 or that the apparatus 1000 may be connected to. The communication interface 1030 provides the apparatus with radio communication capabilities to communicate in the cellular communication system. The communication interface may, for example, provide a radio interface to terminal devices. The apparatus 1000 may further comprise another interface towards a core network such as the network coordinator apparatus and/or to the access nodes of the cellular communication system. The apparatus 1000 may further comprise a scheduler 1040 that is configured to allocate resources.

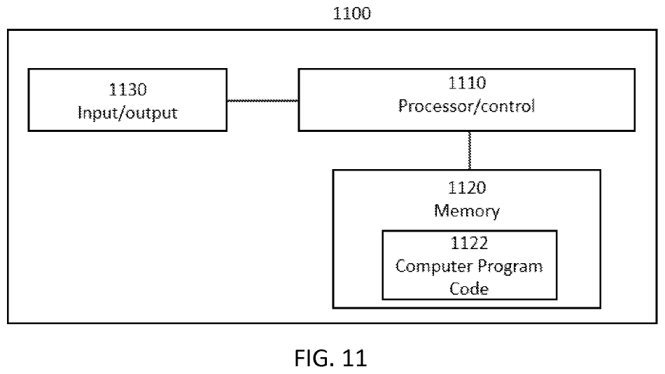

The apparatus 1100 of FIG. 11 illustrates an exemplary embodiment of an apparatus such as, or comprised in, an AMF. The apparatus may comprise, for example, a circuitry or a chipset applicable for realizing some of the described exemplary embodiments. The apparatus 1100 may be an electronic device comprising one or more electronic circuitries. The apparatus 1100 may comprise control circuitry 1110 such as at least one processor, and at least one memory 1120 including a computer program code (software) 1122 wherein the at least one memory and the computer program code (software) 1122 are configured, with the at least one processor, to cause the apparatus 1100 to carry out some of the exemplary embodiments described above.

The memory 1120 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data.

The apparatus 1100 may further comprise an input/output unit 1130 (interface) connected to the processor 1110. The input/output unit 1130 may be used for communicating with one or more core network entities, base stations, registers, other network elements, or the like. The input/output unit 1130 may be a combined unit comprising communication equipment towards several network elements, or it may comprise a distributed structure with a plurality of different interfaces for different network elements.

As used in this application, the term “circuitry” may refer to one or more or all of the following:
a. hardware-only circuit implementations (such as implementations in only analog and/or digital circuitry) and
b. combinations of hardware circuits and software, such as (as applicable):
   i. a combination of analog and/or digital hardware circuit(s) with software/firmware and
   ii. any portions of hardware processor(s) with software (including digital signal processor(s)), software, and memory(ies) that work together to cause an apparatus, such as a mobile phone, to perform various functions) and
c. hardware circuit(s) and or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of exemplary embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

### LIST OF ABBREVIATIONS

4G: fourth generation
5G: fifth generation
ADC: analog-to-digital converter
AMF: access and mobility management function
ASIC: application-specific integrated circuit
BBU: baseband unit
CN: core network
CPS: cyber-physical system
CSSP: customer-specific standard product
CU: central unit
DAC: digital-to-analog converter
DFE: digital front end
DRAM: dynamic random-access memory
DSP: digital signal processor
DSPD: digital signal processing device
DU: distributed unit
EEPROM: electronically erasable programmable read-only memory
FDM: frequency-division multiplexing
FPGA: field programmable gate array
GEO: geostationary earth orbit
gNB: next generation nodeB/5G base station
GPU: graphics processing unit
HNB-GW: home node B gateway
IE: information element
IMS: internet protocol multimedia subsystem
IoT: internet of things
L1: Layer 1
L2: Layer 2
L3: Layer 3
LCD: liquid crystal display
LCoS: liquid crystal on silicon
LED: light emitting diode
LEO: low earth orbit
LTE: long term evolution
LTE-A: long term evolution advanced
M2M: machine-to-machine
MANET: mobile ad-hoc network
MBS: multicast and broadcast services
MB-SMF: multicast/broadcast session management function
MEC: multi-access edge computing
MIMO: multiple input and multiple output
MME: mobility management entity
mMTC: massive machine-type communications
NGC: next generation core
NG-RAN: next generation radio access network
NR: new radio
NVF: network function virtualization
PCS: personal communications services
PDA: personal digital assistant
PDU: protocol data unit
P-GW: packet data network gateway
PLD: programmable logic device
PRACH: physical random-access channel
PROM: programmable read-only memory
RA: registration area
RACH: random access channel
RAM: random-access memory
RAN: radio access network
RAP: radio access point
RAT: radio access technology
RI: radio interface
ROM: read-only memory
RRC: radio resource control
RU: radio unit
RX: receiver
SA: service area
SDN: software defined networking
SDRAM: synchronous dynamic random-access memory
S-GW: serving gateway
SIB: system information block
SIB-1: system information block type 1
SIM: subscriber identification module
SMF: session management function
SoC: system-on-a-chip
TAI: tracking area identifier
TRX: transceiver
TX: transmitter
UE: user equipment
UMTS: universal mobile telecommunications system
UTRAN: UMTS radio access network
UWB: ultra-wideband
vCU: virtualized central unit
vDU: virtualized distributed unit
WCDMA: wideband code division multiple access
WiMAX: worldwide interoperability for microwave access
WLAN: wireless local area network

1. An apparatus comprising at least one processor, and at least one memory including computer program code, wherein the at least one memory and the computer program code are configured, with the at least one processor, to cause the apparatus to:
determine an alternative set of random-access resources based at least partly on an estimated number of idle and/or inactive terminal devices, wherein the alternative set of random-access resources comprises at least one or more random-access resources that are not comprised in an initial set of random-access resources indicated by an initial set of configuration parameters;
transmit, to the estimated number of idle and/or inactive terminal devices, a group paging message indicating at least the alternative set of random-access resources and a group identifier.

2. The apparatus according to claim 1, wherein the apparatus is further caused to:
transmit, to the estimated number of idle and/or inactive terminal devices, the initial set of configuration parameters comprising at least a pattern of random-access resources;
wherein the alternative set of random-access resources comprises a number of repetitions of the pattern of random-access resources, wherein the number of repetitions is indicated at least partly by a coefficient comprised in the group paging message.

3. The apparatus according to claim 1, wherein the alternative set of random-access resources is indicated at least partly by a second value of a first index for overriding a first value of the first index comprised in the initial set of configuration parameters with the second value, wherein the second value is comprised in the group paging message;
wherein the first value comprised in the initial set of configuration parameters indicates an initial amount of time resources comprised in the initial set of random-access resources;
wherein the second value indicates an alternative amount of time resources comprised in the alternative set of random-access resources.

4. The apparatus according to claim 1, wherein the alternative set of random-access resources is indicated at least partly by a fourth value of a parameter, wherein the fourth value indicates to increase an initial amount of frequency resources comprised in the initial set of random-access resources, and wherein the fourth value is comprised in the group paging message;
wherein the initial amount of frequency resources is indicated by a third value of the parameter comprised in the initial set of configuration parameters.

5. The apparatus according to claim 1, wherein the group paging message comprises a second index indicating an alternative set of configuration parameters from multiple sets of configuration parameters to be used instead of the initial set of configuration parameters, wherein the alternative set of configuration parameters at least partly indicates the alternative set of random-access resources.

6. The apparatus according to claim 1, wherein the group paging message further comprises at least one of a maximum number of attempts, a number of system frames, and/or a time period for using the alternative set of random-access resources starting from a reception of the group paging message.

7. The apparatus according to claim 1, wherein the estimated number of idle and/or inactive terminal devices is determined based at least partly on a first number of terminal devices in a radio resource control inactive state and/or a second number of terminal devices indicated in a paging message received from an access and mobility management function.

8. The apparatus according to claim 1, wherein the apparatus is comprised in a base station.

9-10. (canceled)

11. An apparatus comprising at least one processor, and at least one memory including computer program code, wherein the at least one memory and the computer program code are configured, with the at least one processor, to cause the apparatus to:
receive a configuration comprising an initial set of random-access resources;
receive a group paging message indicating an alternative set of random-access resources, wherein the alternative set of random-access resources comprises at least one or more random-access resources that are not comprised in the initial set of random-access resources;
transmit a first random-access message using a first random-access resource selected from the alternative set of random-access resources;
wherein the apparatus is comprised in a terminal device.

12. The apparatus according to claim 11, wherein the apparatus is further caused to:
transmit, if a random-access procedure based on the first random-access message fails, a second random-access message using a second random-access resource selected from the alternative set of random-access resources.

13. The apparatus according to claim 11, wherein the apparatus is further caused to:
transmit, if a random-access procedure based on the first random-access message fails, a second random-access message using a third random-access resource selected from the initial set of random-access resources.

14. A method comprising:
determining, by a base station, an alternative set of random-access resources based at least partly on an estimated number of idle and/or inactive terminal devices, wherein the alternative set of random-access resources comprises at least one or more random-access resources that are not comprised in an initial set of random-access resources indicated by an initial set of configuration parameters;
transmitting, to the estimated number of idle and/or inactive terminal devices, a group paging message indicating at least the alternative set of random-access resources and a group identifier.

15. (canceled)

16. A method comprising:
receiving, by a terminal device, a configuration comprising an initial set of random-access resources;
receiving, by the terminal device, a group paging message indicating an alternative set of random-access resources, wherein the alternative set of random-access resources comprises at least one or more random-access resources that are not comprised in the initial set of random-access resources;
transmitting, by the terminal device, a first random-access message using a first random-access resource selected from the alternative set of random-access resources.

17-23. (canceled)

24. The method according to claim 14, further comprising:
transmitting, to the estimated number of idle and/or inactive terminal devices, the initial set of configuration parameters comprising at least a pattern of random-access resources;
wherein the alternative set of random-access resources comprises a number of repetitions of the pattern of random-access resources, wherein the number of repetitions is indicated at least partly by a coefficient comprised in the group paging message.

25. The method according to claim 14, wherein the alternative set of random-access resources is indicated at least partly by a second value of a first index for overriding a first value of the first index comprised in the initial set of configuration parameters with the second value, wherein the second value is comprised in the group paging message;
wherein the first value comprised in the initial set of configuration parameters indicates an initial amount of time resources comprised in the initial set of random-access resources;
wherein the second value indicates an alternative amount of time resources comprised in the alternative set of random-access resources.

26. The method according to claim 14, wherein the alternative set of random-access resources is indicated at least partly by a fourth value of a parameter, wherein the fourth value indicates to increase an initial amount of frequency resources comprised in the initial set of random-access resources, and wherein the fourth value is comprised in the group paging message;
wherein the initial amount of frequency resources is indicated by a third value of the parameter comprised in the initial set of configuration parameters.

27. The method according to claim 14, wherein the group paging message comprises a second index indicating an alternative set of configuration parameters from multiple sets of configuration parameters to be used instead of the initial set of configuration parameters, wherein the alternative set of configuration parameters at least partly indicates the alternative set of random-access resources.

28. The method according to claim 16, further comprising:
transmitting, if a random-access procedure based on the first random-access message fails, a second random-access message using a second random-access resource selected from the alternative set of random-access resources.

29. The method according to claim 16, further comprising:
transmitting, if a random-access procedure based on the first random-access message fails, a second random-access message using a third random-access resource selected from the initial set of random-access resources.

30. The apparatus according to claim 11, wherein the apparatus is comprised in a terminal device.
